(19) United States
(12) Patent Application Publication
(10) Pub. No.: US 2024/0353211 A1
(43) Pub. Date: Oct. 24, 2024

(54) Trim Block Measuring Guide Device

(71) Applicants: Roy Blanchette, Prince George (CA); Wendy Blanchette, Prince George (CA)

(72) Inventors: Roy Blanchette, Prince George (CA); Wendy Blanchette, Prince George (CA)

(21) Appl. No.: 18/503,317

(22) Filed: Nov. 7, 2023

Related U.S. Application Data
(60) Provisional application No. 63/497,315, filed on Apr. 20, 2023.

(51) Int. Cl. G01B 3/04

(52) U.S. Cl. CPC G01B 3/04

(57) ABSTRACT

A trim block measuring guide device is disclosed herein. The device is comprised of a body and measurement lines which are strategically designed to create a standardized measurement tool for use in carpentry, home improvement, crafting, and other such disciplines. In one ideal embodiment, the device is designed to align with the opening of a window, door, or similar surface, and is meant to provide a standardized method of measurement for the application of trim and other applicable projects. The device allows users to save time and effort when making measurements whilst also improving overall accuracy and efficiency.

### CROSS-REFERENCE TO RELATED APPLICATION

The present application claims priority to, and the benefit of, U.S. Provisional Application No. 63/497,315, which was filed on Apr. 20, 2023, and is incorporated herein by reference in its entirety.

### FIELD OF THE INVENTION

The present invention relates generally to the field of measuring devices. More specifically, the present invention relates to a trim block measuring guide device. The device is comprised of a block containing strategically placed, detailed grooves and can be placed up against an object to produce a simplified and standardized measurement surface. Accordingly, the present disclosure makes specific reference thereto. Nonetheless, it is to be appreciated that aspects of the present invention are also equally applicable to other like applications, devices, and methods of manufacture.

### BACKGROUND

Making measurements during carpentry, home improvement, crafting, and other such tasks can be a difficult, imperfect, and time-consuming process, even for professionals. Inaccurate measurements can lead to mistakes, poor craftsmanship, and structural and aesthetic weaknesses. Standard measuring techniques are often imperfect and time-consuming.

Therefore, there exists a long-felt need in the art for a device that improves upon standard techniques of measurement. More specifically, there exists a long-felt need in the art for a trim block measuring guide device that can be applied to a surface or object in need of measurement to produce accurate and standardized measurements in a simple and timely manner. Furthermore, there exists a long-felt need in the art for a trim block measuring guide device that can be applied to a surface or object in need of measurement and used to produce accurate and standardized measurement figures in a simple and timely manner, wherein the device can be universally applied to virtually any surface, material, or object.

The subject matter disclosed and claimed herein, in one embodiment thereof, comprises a trim block measuring guide device. The device is comprised of a body preferably made from a hard, durable material, such as wood, metal, or plastic. The body of the device is designed in a strategic shape which allows for a multitude of measurement capabilities. The body is comprised primarily of at least one base and at least one top plate, each of which includes a fastener, ideally made from hook-and-loop fasteners, magnets, or a threaded fastening method, wherein the fastener on the base aligns with the fastener on the top plate, allowing them to be connected to form the body. The top plate is also comprised of measurement lines which provide the user with standardized reference points with which to measure the object or material at hand.

In this manner, the trim block measuring guide device of the present invention accomplishes all the foregoing objectives and provides a device that improves upon traditional methods of measurement. More specifically, the trim block measuring guide device can be applied to virtually any material, object, or surface to provide the user with a simplified, standardized, and accurate method of measuring the object. Furthermore, the device can be universally applied to virtually any surface, material, or object.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trim block measuring guide device comprised primarily of a body, base, top plate, fasteners, and measurement lines. The device is designed to improve upon standard measurement techniques in the fields of carpentry, home improvement, crafting, and many others, wherein the device reduces time spent measuring, improves accuracy, and provides standardized points of reference.

The device is comprised of a body that is primarily comprised of a base and a top plate, all of which are preferably made from a hard, durable material, such as wood, metal, or plastic. The base is comprised of a top surface and a fastener. The fastener is preferably made from hook-and-loop fasteners, magnets, or a threaded fastening element. The top plate is comprised of a bottom surface, fastener, top surface, outside edge, and measurement lines. The fastener is preferably made from hook-and-loop fasteners, magnets, or a threaded fastening element, and is designed so that it aligns with the fastener on the base, allowing the base and top plate to be fastened together. The body of the device, comprised of the base and top plate, is designed in a strategic shape that allows for a multitude of measurement capabilities. In an ideal embodiment of the device, there is a difference between the width of the base and the top plate which creates a distance between the outermost edge of the base and the outside edge of the top plate, wherein this open space creates a square angle.

During use, the base and top plate are fastened together using the aligning fasteners on each. Then, the device is aligned with the object, material, or surface in need of measurement. Next, the user of the device refers to the measurement lines on the device, and, if desired, creates corresponding marks on the surface being measured. As a result, a standard measurement is created and can be replicated accurately and efficiently whenever necessary.

The present invention is also comprised of a method of using the device. First, a device is provided comprised of a body; a base comprised of a top surface and a fastener; a top plate comprised of a bottom surface, a fastener, a top surface, an outside edge, and measurement lines; and a distance creating a square angle. Then, the base is fastened to the top plate via the fasteners. Next, the device is strategically aligned with the object, material, or surface in need of measurement. A user can then create a mark on the surface corresponding to the measurement lines on the device.

The present invention is also comprised of a second method of using the device. In this secondary method of using the device, the device is not comprised of fastening methods, rather, the device is provided in a single, non-detachable entity strategically designed to provide the ideal shape and angles for the device's intended field of use. First, a device is provided comprised of a body; a base comprised of a top surface; a top plate comprised of a bottom surface, a top surface, an outside edge, measurement lines; and a distance creating a desired strategic angle. Then, the device is strategically aligned with the object, material, or surface in need of measurement. A user can then create a mark on the surface corresponding to the measurement lines on the device.

Accordingly, the trim block measuring guide device of the present invention is particularly advantageous as it provides a device that improves upon traditional methods of measurement. More specifically, the trim block measuring guide device can be applied to virtually any material, object, or surface to provide the user with a simplified, standardized, and accurate method of measuring the object. Furthermore, the device can be universally applied to virtually any surface, material, or object. In this manner, the trim block measuring guide device provides a device that allows a user to easily mark a precisely measured line around a door, window, or other desired object, surface, or material.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a trim block measuring guide device of the present invention in accordance with the disclosed architecture;

FIG. 2 illustrates a side view of one potential embodiment of a trim block measuring guide device of the present invention in accordance with the disclosed architecture;

FIG. 3 illustrates a top view of one potential embodiment of a trim block measuring guide device of the present invention in accordance with the disclosed architecture;

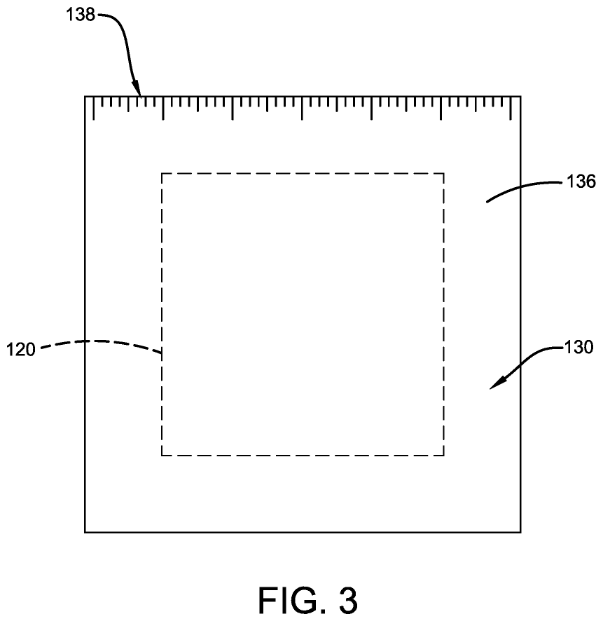

FIG. 4 illustrates a cross-sectional view of one potential embodiment of a trim block measuring guide device of the present invention while applied in an opening in accordance with the disclosed architecture;

FIG. 5 illustrates a front view of one potential embodiment of a trim block measuring guide device of the present invention while applied in an opening in accordance with the disclosed architecture;

FIG. 6 illustrates a flowchart of a method of using one potential embodiment of a trim block measuring guide device of the present invention in accordance with the disclosed architecture; and

FIG. 7 illustrates a flowchart of a method of using one potential embodiment of a trim block measuring guide device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that improves upon standard techniques of measurement. More specifically, there exists a long-felt need in the art for a trim block measuring guide device that can be applied to a surface or object in need of measurement to produce accurate and standardized measurements in a simple and timely manner. Furthermore, there exists a long-felt need in the art for a trim block measuring guide device that can be applied to a surface or object in need of measurement and used to produce accurate and standardized measurement figures in a simple and timely manner, wherein the device can be universally applied to virtually any surface, material, or object.

The present invention, in one exemplary embodiment, is comprised of a trim block measuring guide device. The device is comprised primarily of a body, base, top plate, fasteners, and measurement lines. The device is designed to improve upon standard measurement techniques in the fields of carpentry, home improvement, crafting, and many others, wherein the device reduces time spent measuring, improves accuracy, and provides standardized points of reference.

More specifically, the device is comprised of a body that is primarily comprised of a base and a top plate, all of which are preferably made from a hard, durable material, such as wood, metal, or plastic. The base is comprised of a top surface and a fastener. The fastener is preferably made from hook-and-loop fasteners, magnets, or a threaded fastening element. The top plate is comprised of a bottom surface, fastener, top surface, outside edge, and measurement lines. The fastener is preferably made from hook-and-loop fasteners, magnets, or a threaded fastening element, and is designed so that it aligns with the fastener on the base, allowing the base and top plate to be fastened together. The body of the device, comprised of the base and top plate, is designed in a strategic shape that allows for a multitude of measurement capabilities. In an ideal embodiment of the device, there is a difference between the width of the base and the top plate which creates a distance between the outermost edge of the base and the outside edge of the top plate, wherein this open space creates a square angle.

During use, the base and top plate are fastened together using the aligning fasteners on each. Then, the device is aligned with the object, material, or surface in need of measurement. Next, the user of the device refers to the measurement lines on the device, and, if desired, creates corresponding marks on the surface being measured. As a result, a standard measurement is created and can be replicated accurately and efficiently whenever necessary.

The present invention is also comprised of a method of using the device. First, a device is provided comprised of a body; a base comprised of a top surface and a fastener; a top plate comprised of a bottom surface, a fastener, a top surface, an outside edge, and measurement lines; and a distance creating a square angle. Then, the base is fastened to the top plate via the fasteners. Next, the device is strategically aligned with the object, material, or surface in need of measurement. A user can then create a mark on the surface corresponding to the measurement lines on the device.

The present invention is also comprised of a second method of using the device. In this secondary method of using the device, the device is not comprised of fastening methods, rather, the device is provided in a single, non-detachable entity strategically designed to provide the ideal shape and angles for the device's intended field of use. First, a device is provided comprised of a body; a base comprised of a top surface; a top plate comprised of a bottom surface, a top surface, an outside edge, measurement lines; and a distance creating a desired strategic angle. Then, the device is strategically aligned with the object, material, or surface in need of measurement. A user can then create a mark on the surface corresponding to the measurement lines on the device.

Accordingly, the trim block measuring guide device of the present invention is particularly advantageous as it provides a device that improves upon traditional methods of measurement. More specifically, the trim block measuring guide device can be applied to virtually any material, object, or surface to provide the user with a simplified, standardized, and accurate method of measuring the object. Furthermore, the device can be universally applied to virtually any surface, material, or object. In this manner, the trim block measuring guide device provides a device that allows a user to easily mark a precisely measured line around a door, window, or other desired object, surface, or material.

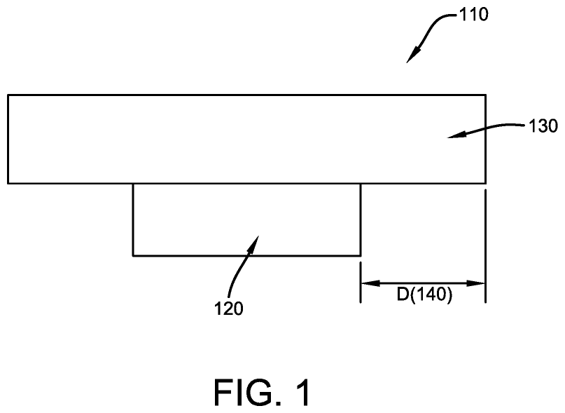

Referring initially to the drawings, FIG. 1 illustrates a side view of one potential embodiment of a trim block measuring guide device 100 of the present invention in accordance with the disclosed architecture. The device 100 is comprised of a body 110 which is primarily comprised of a base 120 and a top plate 130 that are preferably square to create right-angled markings. However, the base 120 and top plate 130 may be any shape in different embodiments. In one embodiment, the base 120 and top place 130 are integrally formed together (i.e., fixedly attached).

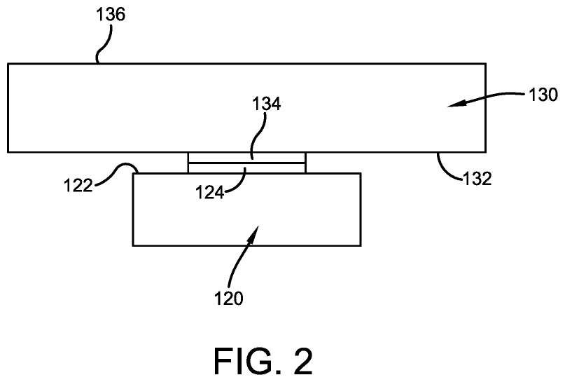

In another embodiment, the base 120 is comprised of a top surface 122 with at least one fastener 124. The top plate 130 is also comprised of a bottom surface 132 with at least one fastener 134 which aligns with the fastener 124 of the base 120, as seen in FIG. 2. The fasteners 124, 134 may be any reciprocating fastener type known as, but not limited to, hook and loop, snap button, magnet, adhesive, male and female, etc.

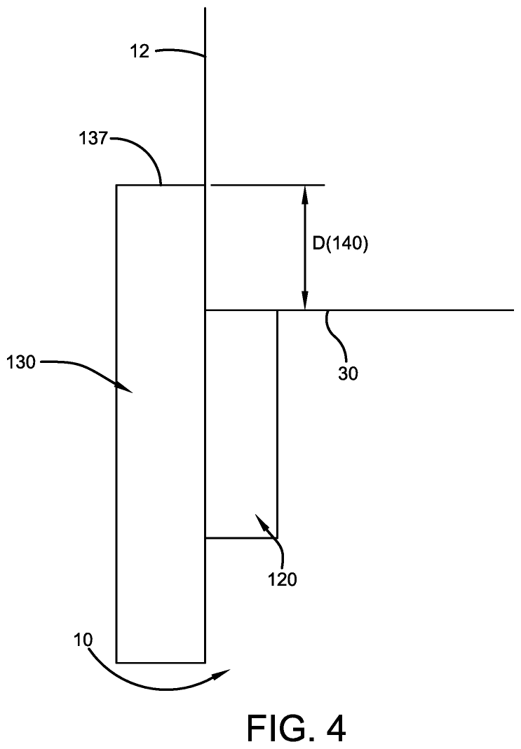

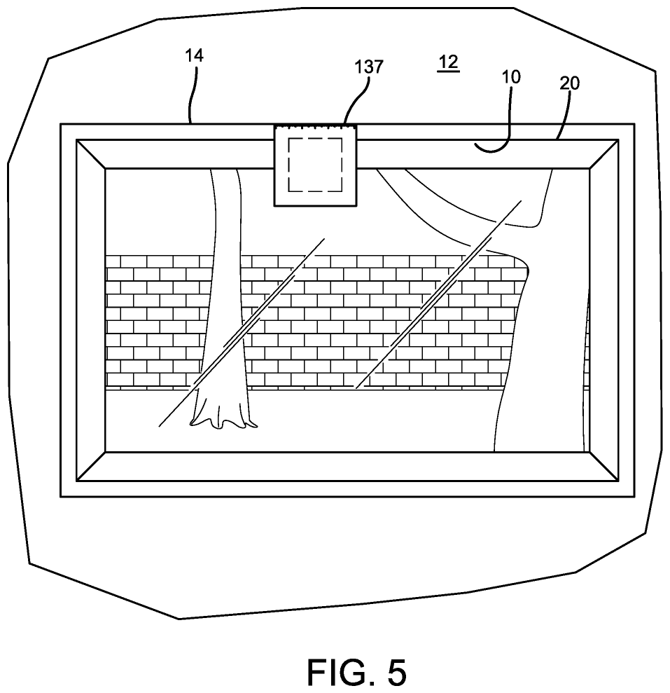

In one embodiment, the device 100 is designed to be aligned and placed within an opening 10, such as a window or door, or other such measurable objects, material, surface, or area, as seen in FIG. 4 and FIG. 5. Then, a portion of top plate 130 extends a uniform distance 140 from the base 120 (and opening 10), wherein the outside edge 137 of the top plate 130 can then be traced to form a line of uniform distance from the opening 10. It should be noted that because the top plate 130 is larger than the base 120, a right handle is created from which the distance 140 is merely the distance from the bottom surface 132 of the plate 130 to the bottom surface of the base 120.

The body 110 is designed in a strategic shape which allows for a multitude of standardized measurement applications. In one ideal embodiment of the device 110, the difference in width between the base 120 and the top plate 130 creates a distance 140 between the outermost edge of the base 120 and the outside edge 137 of the top plate 130, wherein this open space creates a right angle that can be aligned with a right angle of an opening 10 on the object or surface being measured to provide quick and efficient uniform measurements. The distance 140 between the base 120 and top plate 130 may be any distance in different embodiments. In an embodiment wherein the base 120 and top plate 130 are attached via fasteners 124, 134, the distance 140 can be adjusted as needed as the fasteners 124, 134 may be repositionable on the base 120 and top plate 130.

During use, the device 100 the base 120 is placed against an object, material, or surface in need of measurement, as best seen in FIG. 4. In this manner, the outside edge 137 of the top plate 130 is parallel with the edge 20 of the opening 10. As a result, a user can easily create a marking 14 (as seen in FIG. 5) by tracing a pencil along the top edge 137. Further, the measurement remains square as the base 120 contacts the upper wall 30 of the opening 10. More specifically, a user may use at least one measurement line 138, of any measurement increment and unit known in the art, to easily trace a marking 14 of a desired length. As a result, a standard measurement is created and can be replicated with accuracy and efficiency whenever needed along the opening 110 via the uniform distance 140 between the base 120 and top plate 130.

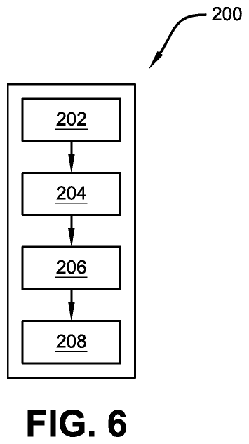

The present invention is also comprised of a method of using 200 the device 100, as pictured in FIG. 6. First, a device 100 is provided comprised of a body 110 comprised of a base 120 and a top plate 130, wherein the base 120 is comprised of a top surface 122 with at least one fastener 124, and the top plate 130 is comprised of at least one outside edge 137 and a bottom surface 132 with at least one fastener 134 [Step 202]. Then, the base 120 is attached to the top plate 130 via aligning fasteners 124, 134, creating the body 110 such that a distance 140 is formed between the base 120 and body 140 [Step 204]. Next, the device 100 is strategically aligned with an object, material, or surface in need of measurement, ideally, such that the device 100 is placed within the opening 10 of a doorway or window such that the outside edge 137 is parallel to the edge 20 of the opening 10 (as seen in FIG. 5), at least one measurement lines 138 of the top plate 130 is visible to the user, and the base 120 contacts the upper wall 30 of the opening 10 and wall 12 above the opening 130 (as seen in FIG. 4) [Step 206]. Then, the user can use a writing utensil to trace along the outside edge 137 of the top plate 10 to create at least one markings 14 on the wall 12 or measurement surface, wherein the user can use the measurement lines 138 of the top plate 130 to make the marking 14 a specific length [Step 208]. As a result, the device 100 can be quickly applied to various openings 10 to create quick, consistent, and uniform markings 14 for applying trim, or for other needs.

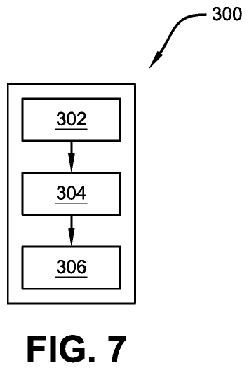

The present invention is also comprised of a second method of using 300 the device 100, as pictured in FIG. 7. In this second method of using 300 the device 100, the device 100 is not comprised of detachable components; rather, the device 100 is provided as a single, non-detaching device strategically designed to provide the ideal shape and angles for the device's 100 intended field of use. First, a device 100 is provided comprised of a body 110, a base 120 attached to a top plate 130 comprised of an outside edge [Step 302]. Next, the device 100 is strategically aligned with an object, material, or surface in need of measurement, ideally, such that the device 100 is placed within the opening 10 of a doorway or window such that the outside edge 137 is parallel to the edge 20 of the opening 10 (as seen in FIG. 5), at least one measurement lines 138 of the top plate 130 is visible to the user, and the base 120 contacts the upper wall 30 of the opening 10 and wall 12 above the opening 10 (as seen in FIG. 4) [Step 304]. Then, the user can use a writing utensil to trace along the outside edge 137 of the top plate 10 to create at least one markings 14 on the wall 12 or measurement surface, wherein the user can use the measurement lines 138 of the top plate 130 to make the marking 14 a specific length [Step 306]. As a result, the device 100 can be quickly applied to various openings 10 to create quick, consistent, and uniform markings 14 for applying trim, or for other needs.

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “trim block measuring guide device” and “device” are interchangeable and refer to the trim block measuring guide device 100 of the present invention.

Notwithstanding the foregoing, the trim block measuring guide device 100 of the present invention and its various components can be of any suitable size and configuration as is known in the art without affecting the overall concept of the invention, provided that they accomplish the above-stated objectives. One of ordinary skill in the art will appreciate the size, configuration, and material of the trim block measuring guide device 100 as shown in the FIGS. are for illustrative purposes only, and many other sizes and shapes of the trim block measuring guide device 100 are well within the scope of the present disclosure. Although the dimensions of the trim block measuring guide device 100 are important design parameters for user convenience, the trim block measuring guide device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trim block measuring guide device comprising:
a base comprised of a first fastener;
a top plate comprised of a second fastener that attaches to the first fastener; and
a measurement line positioned on a top surface of the plate.

2. A trim block measuring guide device of claim 1, wherein the first fastener is comprised of a hook and loop fastener, a snap button fastener, a magnet fastener, an adhesive fastener, a male fastener, or a female fastener.

3. A trim block measuring guide device of claim 1, wherein the second fastener is comprised of a hook and loop fastener, a snap button fastener, a magnet fastener, an adhesive fastener, a male fastener, or a female fastener.

4. A trim block measuring guide device of claim 1, wherein the first fastener is positioned on a top surface of the base.

5. A trim block measuring guide device of claim 1, wherein the second fastener is positioned on a bottom surface of the top plate.

6. A trim block measuring guide device of claim 1, wherein the base is comprised of a square shape.

7. A trim block measuring guide device of claim 1, wherein the top plate is comprised of a square shape.

8. A trim block measuring guide device of claim 1, wherein the top plate is larger in size than the base.

9. A trim block measuring guide device of claim 1, wherein the measurement line is comprised of a measurement increment.

10. A trim block measuring guide device of claim 1, wherein the top plate is comprised of an outside edge.

11. A trim block measuring guide device comprising:
a base;
a top plate attached to the base; and
a measurement line positioned on a top surface of the top plate.

12. A trim block measuring guide device of claim 11, wherein the base is comprised of a square shape.

13. A trim block measuring guide device of claim 11, wherein the top plate is comprised of a square shape.

14. A trim block measuring guide device of claim 11, wherein the top plate is larger in size than the base.

15. A trim block measuring guide device of claim 11, wherein the measurement line is comprised of a measurement increment.

16. A trim block measuring guide device of claim 11, wherein the top plate is comprised of an outside edge.

17. A method of using a trim block measuring guide device, the method comprising the following steps:
providing a trim block measuring guide device comprised of a base and a top plate;
placing the trim block measuring guide device within an opening such that the base contacts the opening and the top plate contacts a wall surface; and
using a writing utensil to trace a marking against an outside edge of the top plate.

18. A method of using a trim block measuring guide device of claim 17, wherein the top plate is comprised of a measuring line.

19. A method of using a trim block measuring guide device of claim 18, wherein the measuring line is comprised of a measuring increment.

20. A method of using a trim block measuring guide device of claim 19 further comprised of a step of using the measuring line to create a marking of a specific distance.
